(19) United States
(12) Patent Application Publication
(10) Pub. No.: US 2008/0049440 A1
(43) Pub. Date: Feb. 28, 2008

(54) Fiber-optic device for secondary lighting systems in aircraft carriers

(75) Inventor: Ekkehard Gaydoul, Gross Bieberau (DE)

Correspondence Address: LERNER GREENBERG STEMER LLP, P O BOX 2480, HOLLYWOOD, FL, 33022-2480, US

(73) Assignee: Schott AG

(21) Appl. No.: 11/649,084

(22) Filed: Jan. 3, 2007

(30) Foreign Application Priority Data
Dec. 31, 2005 (DE) 10 2005 063 208.4

(51) Int. Cl. F21V 8/00

(52) U.S. Cl. 362/556

(57) ABSTRACT

A fiber-optic device for functional and decorative interior lighting of aircraft cabins has at least one central light source and at least one fiber-optic waveguide system. The waveguides guide light from the light source to a lighting location. The waveguides are combined at a light-inlet side to form a light-receiving surface corresponding to the light source. The waveguides have at least one glass-fiber bundle with light outlet-side ends of glass fibers forming a light outlet surface preshaped as a point light, line of lights or flat light. Alternatively, a waveguide has at least one monofiber light-guiding rod with a diameter of 2-8 mm, preferably 3 mm, side light-emitting properties and a light outlet surface in the form of a line of lights or flat light. The device reduces the number of active power-consuming light sources in the cabin. One central light source supplies power to a plurality of locations and the light source can be outside the cabin. A considerable proportion of wiring in cabin paneling is thus dispensed with. The waveguides can be laid at any desired locations in the wall paneling region of the cabin. The device provides a simple, cost-effective and space-saving system of point, linear or flat lighting without special measures for fire prevention.

### CROSS-REFERENCE TO RELATED APPLICATION

This application claims the priority, under 35 U.S.C. §119, of German Patent Application DE 10 2005 063 208.4, filed Dec. 31, 2005; the prior application is herewith incorporated by reference in its entirety.

### BACKGROUND OF THE INVENTION

### Field of the Invention

The invention relates to a fiber-optic device for secondary lighting systems in aircraft cabins.

In aircraft passenger cabins, especially those in wide-body aircraft, secondary lighting systems which are used exclusively for functional and decorative purposes, in contrast to primary lighting such as environmental or reading lighting, have various constructions. Firstly, such secondary lighting devices include point lighting of decorative internal elements, symbols, signs, company logos, markings as well as individual elements in flat light displays, such as a starry sky stylized on the cabin ceiling or other ceiling or wall decorations. Secondly, they are used as flat backlighting for signs and shapes, for example seat numbers, or as lines of light for accentuating edge or path markings, for example in floor guiding systems for identifying escape routes. Lighting systems with low light intensity are sufficient for that purpose due to the low environmental brightness in aircraft cabins.

Either individual LEDs as point lighting devices or LED groups as lines of light, are used in known secondary lighting systems. LED-lit plastic-fiber systems, for example, are used as an alternative. Those systems are used to produce lines of light, for example for accentuating edges or identifying escape routes, or flat lighting devices, for example backlighting of seat numbers or large flat “mood lights” on the cabin ceiling.

The need for optimization of installation space in behind-the-wall installation, for example for wiring or holders, in aircraft construction, as well as the requirements for fire prevention and flammability of lighting fittings and electrical supply lines in the cabin paneling, are increasingly leading to specific materials or light-producing technologies for use in aircraft construction being classified as dangerous and to their fitting not being permitted. Additional safety measures, such as the linear guidance of electrical cables or lines made of specific polymeric-fiber materials, but also the secure mounting of LEDs on bases or holders, also render behind-the-wall installation in aircraft cabins complicated and expensive.

Due to their configuration as monofibers typically having a 1 mm fiber diameter, and to the resulting limited bending radius, polymeric optical waveguides can be used only to a limited degree in the difficult installation conditions in aircraft cabins. That is because the space required there for optimum light distribution and light guidance is lacking in behind-the-wall fitting in the aircraft cabin.

In particular, polymeric optical waveguides do not comply with the requirements of fire prevention standards for aircraft (e.g. JAR 25.869(a)(4)), which could result in functional as well as financial limitations for alternatives of secondary lighting systems in aircraft construction.

### SUMMARY OF THE INVENTION

It is accordingly an object of the invention to provide a fiber-optic device for secondary lighting systems in aircraft cabins, which overcomes the hereinafore-mentioned disadvantages of the heretofore-known devices of this general type and which, in particular, provides a cost-effective device for secondary interior lighting in aircraft cabins which both complies with regulations relating to fire prevention technology and also requires little installation space for cable routing, installing lights and light sources, and can additionally be installed in or behind a cabin wall in a simple and safe manner.

With the foregoing and other objects in view there is provided, in accordance with the invention, a fiber-optic device for the functional and decorative interior lighting of aircraft cabins. The fiber-optic device comprises at least one central light source and at least one fiber-optic waveguide system with optical waveguides for guiding light from the light source to a lighting location. The optical waveguides are combined on a light-inlet side to form a light-receiving surface corresponding to the light source and the optical waveguides have at least one glass-fiber bundle. The at least one glass-fiber bundle has glass fibers with light outlet-side ends forming a light outlet surface. The light outlet surface is preshaped into a point light, a line of lights or a flat light.

One advantage of the invention is that the number of the active power-consuming light sources in the aircraft cabin can be reduced, since one central light source can supply electrical power to a plurality of lighting locations, wherein the central light source can be disposed outside the aircraft cabin in particularly protected regions of the aircraft. This makes it possible to dispense with a considerable portion of the electrical wiring in the cabin paneling for which particular technical fire prevention measures are necessary. Since optical waveguides have no electromagnetic effect on their environment, and therefore there is no electromagnetic interference on neighboring electrical wiring, the optical waveguides can be laid at any desired locations in the region of the wall paneling of the aircraft cabin.

The light is advantageously emitted at the lighting location in the aircraft cabin without the generation of heat, so that there is no need for special measures for fire prevention with respect to the generation of light at the lighting location.

The device according to the invention can be used to achieve, in a simple, cost-effective and space-saving manner, systems of point, linear or flat lighting devices, for example for accentuating edges or identifying escape routes, backlighting of seat numbers or individual elements of large flat “mood lights” on the cabin ceiling. Furthermore, optimization of installation space in behind-the-wall installations is possible due to the use of the device according to the invention. If the lighting locations are distributed optimally, the optical waveguides can be correspondingly laid in a space-saving manner.

In accordance with another feature of the invention, the glass fibers are pressed together at the light outlet-side ends to form a light-guiding rod or a light panel or woven to form a fabric. This means that the light outlet surface can be advantageously matched to the intended light effect. Thus, backlighting is possible simply through the use of flat emission of light, which is achieved by light panels and light fabrics. Lines of lights, as are commonly used for path or step markings, can be achieved by side-light fibers.

In accordance with a further feature of the invention, the glass fibers have side-emitting properties at the light outlet-side ends. This achieves linear or flat emission of light at the lighting location. The light is emitted uniformly through the side surface of the individual glass fibers of the optical waveguide. In the case of pressed-together or woven ends of the optical waveguides, the flat lighting effect can thus be intensified.

In accordance with an added feature of the invention, the glass fibers have a diameter in a range between 30 μm and 100 μm, preferably 53 μm. These glass fibers as well as optical waveguides produced therefrom have high flexibility because small bending radii can be achieved with them. The optical waveguides can be laid in a simple and cost-effective manner, with good optimization being possible when using the available installation space.

In accordance with an additional feature of the invention, the optical waveguides have a mounting board at the light outlet-side ends, on which the glass-fiber ends are disposed in such a manner that they are distributed on one plane.

In accordance with yet another feature of the invention, it is advantageous if the glass fiber bundle has a diameter of 0.5 mm-3.0 mm, preferably 1.0 mm, and if 280 fibers are used in one glass-fiber bundle, each with a diameter of 0.53 μm per glass fiber, as is advantageous in terms of production technology, which results in an optical waveguide thickness of about 1 mm.

In accordance with yet a further feature of the invention, glass and/or Kevlar filaments are wrapped around the glass-fiber bundle. The wrapping allows the glass fibers to be combined to form glass-fiber bundles and further wrapping using protective sheathing.

In accordance with yet an added feature of the invention, as an alternative or in addition to wrapping, it is possible for the glass-fiber bundle to have a protective sheath of glass fabric, preferably made of glass/silk mesh. The protective sheath offers protection against mechanical damage to the optical waveguides during fitting and maintenance, in particular optimum protection of the glass fibers against fiber fraction.

In accordance with yet an additional feature of the invention, the optical waveguide has an overall diameter of 2.0 mm, preferably with a maximum tolerance value of ±0.2 mm.

In accordance with still another feature of the invention, the optical waveguide has at least one individual end sleeve, in which the glass-fiber bundle is fixedly installed at the light outlet-side end in such a way that it is fixed to the light outlet surface and, at the installation location, in such a manner that it is disposed with the light outlet surface at the lighting location in the aircraft cabin. The individual end sleeve is disposed loosely on the optical waveguide. The ends of the glass fibers are crimped together with the individual end sleeve during installation in such a way that the light outlet surface is disposed at the lighting location in the desired manner and at the desired distance from the light inlet surface. It is possible in this case that the individual end sleeve both holds together the glass fibers to form a light outlet surface and fastens the end of the optical waveguide at the lighting location.

With the objects of the invention in view, there is also provided a fiber-optic device for the functional and decorative interior lighting of aircraft cabins. The fiber-optic device comprises at least one central light source and at least one fiber-optic waveguide system with optical waveguides for guiding light from the light source to a lighting location. The optical waveguides are gathered together at a light-inlet side to form a light-receiving surface corresponding to the light source. The optical waveguides include at least one monofiber light-guiding rod having a diameter of 2-8 mm, preferably 3 mm, side light-emitting properties and a light outlet surface in the form of a line of lights or a flat light.

This embodiment of the invention can advantageously be used to provide robust lines of light or flat lighting devices. The entire longitudinal side or designated sections of the optical waveguide serve in this case as a light outlet surface through which the light is emitted, depending on the intended side light-emitting properties. The side light-emitting properties can be produced through the use of deliberate impurities in the glass material, such as inclusions of air, or by the choice of suitable glass materials of the monofiber light-guiding rod for manufacture or by deliberate treatment of the glass surface of the monofiber light-guiding rod. This embodiment according to the invention can thus advantageously be used for producing side and floor markings, as are common in path or step markings.

In accordance with a concomitant feature of the invention, the central light source includes at least one LED. The light source can, in this case, be disposed outside the aircraft cabin. It likewise provides that the light source is installed in designated safety receptacles inside the aircraft cabin. One or more light sources can advantageously be provided for the different lighting functions in the aircraft cabin. The waveguides can be laid between the light source and the lighting location in such a way that they are integrated behind or on or in the cabin wall.

Other features which are considered as characteristic for the invention are set forth in the appended claims.

Although the invention is described herein as embodied in a fiber-optic device for secondary lighting systems in aircraft cabins, it is nevertheless not intended to be limited to the details given, since various modifications and structural changes may be made therein without departing from the spirit of the invention and within the scope and range of equivalents of the claims.

The construction and method of operation of the invention, however, together with additional objects and advantages thereof, will be best understood from the description of specific embodiments provided herein.

### DESCRIPTION OF THE PREFERRED EMBODIMENT

Referring now to the invention in detail, it is noted that a light source, for example an LED, is preferably used which lights the light inlet end of the fiber-optic device. For this purpose, the fiber-optic device has several hundred or, depending on construction and lighting function, even several thousand individual glass fibers with a typical individual diameter of 30 to 100 μm, which are combined at the light inlet end to form a common light inlet surface.

The glass fibers are bundled from the light inlet surface to form individual optical waveguides. The optical waveguides are used to cover the distance between the light source and the lighting location. Each optical waveguide has at least one light outlet end with an associated light outlet surface. Depending on the application, such as in point lighting distributed on one plane, one optical waveguide also has a plurality of light outlet ends with respective associated light outlet surfaces. To this end, the glass-fiber bundle of the optical waveguide is further divided into bundles with fewer glass fibers. As an alternative, correspondingly coupled distribution locations are provided which are used to distribute light from the optical waveguide to a plurality of downstream optical waveguides or glass-fiber bundles.

Individual glass fibers, glass-fiber bundles or optical waveguides can be grouped together or distributed at the lighting location, wherein the light outlet ends may be disposed on mounting boards or coupled to diffusing plates or monofiber rods. Depending on the lighting function of the light output coupling at the lighting location, point lighting devices, lines of lights or flat lighting devices are thus possible, which advantageously have uniform illumination capability.

Besides the above-described light output coupling, the light outlet end of an optical waveguide or the light outlet surfaces of the glass fibers can, according to the invention, be in the form of a flat ribbon or fabric or netting. It has proven to be advantageous in this context for the glass fibers of the optical waveguide themselves or connection elements coupled thereto to have side-emitting properties. This can be accomplished by surface treatment or deliberate impurities in the designated regions when manufacturing the glass fibers.

The optical waveguides are preferably routed, in the region between the light source and the lighting location, as individual glass-fiber bundles which are accommodated in protective sheathings made of temperature-resistant and fire-resistant material, such as a glass fabric. The glass-fiber bundle in this case can be pre-wrapped using filaments made of glass, Kevlar or a similar material.

The optical waveguides can be laid even in constrained conditions due to the flexibility of the optical waveguides, with the bending radii of the monofibers being in the mm range, and the high flexibility of the glass fabric intended for the protective sheath. This allows further optimization of the installation space which is available for behind-the-wall fittings in the aircraft cabin.

The flame resistance and the chemical neutrality (smoke-free in the case of externally induced generation of heat) of the glass being used and the advantageous properties of glass in relation to the protective sheathing provided by the invention, contribute significantly to improving safety in aircraft cabins. The device according to the invention can be used to meet more stringent requirements relating to safety and fire-prevention standards for aircraft construction or aircraft operation, such as JAR Standard 25.869.

I claim:

1. A fiber-optic device for the functional and decorative interior lighting of aircraft cabins, the fiber-optic device comprising:
at least one central light source;
at least one fiber-optic waveguide system with optical waveguides for guiding light from said light source to a lighting location;
said optical waveguides being combined on a light-inlet side to form a light-receiving surface corresponding to said light source and said optical waveguides having at least one glass-fiber bundle;
said at least one glass-fiber bundle having glass fibers with light outlet-side ends forming a light outlet surface; and
said light outlet surface being preshaped into a shape selected from the group consisting of a point light, a line of lights and a flat light.

2. The fiber-optic device according to claim 1, wherein said glass fibers are pressed together at said light outlet-side ends to form a structure selected from the group consisting of a light-guiding rod, a light panel and a woven fabric.

3. The fiber-optic device according to claim 1, wherein said glass fibers have side-emitting properties at said light outlet-side ends.

4. The fiber-optic device according to claim 1, wherein said glass fibers have a diameter in a range between 30 μm and 100 μm.

5. The fiber-optic device according to claim 4, wherein said glass fibers have a diameter of 53 μm.

6. The fiber-optic device according to claim 1, wherein said optical waveguides have a mounting board at said light outlet-side ends, and said glass-fiber ends are disposed on said mounting board and distributed on one plane.

7. The fiber-optic device according to claim 1, wherein said at least one glass-fiber bundle has a diameter of 0.5 mm-3.0 mm.

8. The fiber-optic device according to claim 7, wherein said at least one glass-fiber bundle has a diameter of 1.0 mm.

9. The fiber-optic device according to claim 1, which further comprises filaments selected from at least one of the group consisting of glass filaments and Kevlar filaments being wrapped around said at least one glass-fiber bundle.

10. The fiber-optic device according to claim 1, wherein said at least one glass-fiber bundle has a protective sheath made of glass fabric.

11. The fiber-optic device according to claim 10, wherein said glass fabric is a glass/silk mesh.

12. The fiber-optic device according to claim 1, wherein said optical waveguide has a total diameter of 2.0 mm.

13. The fiber-optic device according to claim 1, wherein said diameter has a maximum tolerance value of ±0.2 mm.

14. The fiber-optic device according to claim 1, wherein said optical waveguide has at least one individual end sleeve in which said at least one glass-fiber bundle is fixedly installed at said light outlet-side end, is fixed to said light outlet surface and is fixedly installed at an installation location and disposed with said light outlet surface at the lighting location in the aircraft cabin.

15. A fiber-optic device for the functional and decorative interior lighting of aircraft cabins, the fiber-optic device comprising:
at least one central light source;
at least one fiber-optic waveguide system with optical waveguides for guiding light from said light source to a lighting location;
said optical waveguides being gathered together at a light-inlet side to form a light-receiving surface corresponding to said light source; and
said optical waveguides including at least one monofiber light-guiding rod having a diameter of 2-8 mm, side light-emitting properties and a light outlet surface with a shape selected from the group consisting of a line of lights and a flat light.

16. The fiber-optic device according to claim 15, wherein said diameter of said at least one monofiber light-guiding rod is 3 mm.

17. The fiber-optic device according to claim 15, wherein said central light source includes at least one LED.
